(19) United States
(12) Patent Application Publication
(10) Pub. No.: US 2015/0159682 A1
(43) Pub. Date: Jun. 11, 2015

(54) HYDRAULIC SYSTEM FOR CONSTRUCTION MACHINE

(71) Applicants: Sang-Ki Bae, Changwon-si (KR); Jae-Hoon Lee, Changwon-si (KR)

(72) Inventors: Sang-Ki Bae, Changwon-si (KR); Jae-Hoon Lee, Changwon-si (KR)

(73) Assignee: VOLVO CONSTRUCTION EQUIPMENT AB, Eskilstuna (SE)

(21) Appl. No.: 14/416,201

(22) PCT Filed: Jul. 27, 2012
(86) PCT No.: PCT/KR2012/006024

§ 371 Date: Jan. 21, 2015

(51) Int. Cl. F15B 20/00; F15B 15/20

(52) U.S. Cl. CPC F15B 20/007; F15B 15/202

(57) ABSTRACT

A hydraulic system provided with a relief valve for a construction machine is disclosed, which can reduce a discharge flow rate of a hydraulic pump when a relief valve is operated. The hydraulic system for a construction machine includes a variable displacement hydraulic pump connected to an engine, an attachment operation device outputting an operation signal in proportion to an operation amount by an operator, an attachment actuator connected to the hydraulic pump to be driven by an operation of the attachment operation device, a control valve installed in a flow path between the hydraulic pump and the attachment actuator and shifted to control a start, a stop, and a direction change of the attachment actuator, an orifice installed in a flow path branched from a discharge flow path of the hydraulic pump, a relief valve installed on a downstream side of the orifice in the flow path, and a controller outputting a control signal to a flow control valve of the hydraulic pump so as to reduce a discharge flow rate of the hydraulic pump when a difference between pressures before and after the orifice exceeds a predetermined value.

### TECHNICAL FIELD

The present invention relates to a hydraulic system for a construction machine. More particularly, the present invention relates to a hydraulic system for a construction machine, which can reduce a discharge flow rate of a hydraulic pump when a relief valve is operated.

### BACKGROUND ART

A hydraulic system for a construction machine in the related art, as illustrated in FIG. 1, includes a variable displacement hydraulic pump (hereinafter referred to as a “hydraulic pump”) 1 connected to an engine (not illustrated); an attachment operation device outputting an operation signal in proportion to an operation amount by an operator; an attachment actuator (e.g., boom cylinder) 3 connected to the hydraulic pump to be driven by an operation of the attachment operation device 2; a control valve 4 installed in a discharge flow path 1a between the hydraulic pump 1 and the attachment actuator 3 and shifted to control a start, a stop, and a direction change of the attachment actuator 3; and a controller 6 outputting a control signal to a flow control valve 5 of the hydraulic pump 1 so as to control a discharge flow rate of the hydraulic pump 1.

Accordingly, if an operator shifts the control valve in a rightward direction as shown in the drawing through operating the attachment operation device 2 so as to perform a boom-up drive, hydraulic fluid that is discharged from the hydraulic pump 1 is supplied to a large chamber of the attachment actuator 3 through the discharge flow path 1a and a spool of the shifted control valve 4 in order. In this case, hydraulic fluid that returns from a small chamber of the attachment actuator 3 that is driven to expand is drained to a hydraulic tank T through the spool of the shifted control valve 4.

In the drawing, the unexplained reference numeral 7 is a relief valve installed in a flow path 8 that is branched from the discharge flow path 1a of the hydraulic pump 1 to drain the hydraulic fluid to the hydraulic tank T when a load that exceeds a predetermined pressure occurs in the discharge flow path 1a.

In the hydraulic system in the related art, if an excessive load occurs in the attachment actuator 3 during working, or the attachment actuator 3 is operated up to a stroke end, the discharge pressure of the hydraulic pump 1 rises up to a predetermined pressure of the relief valve 7, and thus the relief valve 7 is shifted to an open state. Through this, the hydraulic fluid that is discharged from the hydraulic pump 1 is entirely drained to the hydraulic tank T through the discharge flow path 1a and the relief valve 7 installed in the flow path 8 in order.

As described above, if an overload that exceeds the predetermined pressure occurs in the discharge flow path 1a, the hydraulic fluid that is discharged from the hydraulic pump 1 to drive the attachment actuator 3 is drained to the hydraulic tank T through the relief valve 7. Due to this, a loss of pressure occurs in the relief valve 7 to deteriorate the fuel efficiency of the equipment.

### DISCLOSURE

### Technical Problem

Therefore, the present invention has been made to solve the above-mentioned problems occurring in the related art, and one embodiment of the present invention is related to a hydraulic system for a construction machine, which can reduce a loss of pressure in a relief valve through reduction of a discharge flow rate of a hydraulic pump when an overload occurs and the discharge pressure of the hydraulic pump exceeds a predetermined value of the relief valve.

### Technical Solution

In accordance with an aspect of the present invention, there is provided a hydraulic system for a construction machine, which includes a variable displacement hydraulic pump connected to an engine; an attachment operation device outputting an operation signal in proportion to an operation amount by an operator; an attachment actuator connected to the hydraulic pump to be driven by an operation of the attachment operation device; a control valve installed in a flow path between the hydraulic pump and the attachment actuator and shifted to control a start, a stop, and a direction change of the attachment actuator; an orifice installed in a flow path branched from a discharge flow path of the hydraulic pump; a relief valve installed on a downstream side of the orifice in the flow path; and a controller outputting a control signal to a flow control valve of the hydraulic pump so as to reduce a discharge flow rate of the hydraulic pump when a difference between pressures before and after the orifice exceeds a predetermined value.

Preferably, the hydraulic system for a construction machine according to the aspect of the present invention may further include a first pressure sensor installed in the discharge flow path of the hydraulic pump to detect in real time a discharge pressure of the hydraulic pump and to transmit a detection signal to the controller; and a second pressure sensor installed in a flow path between the orifice and the relief valve to detect in real time a pressure on the downstream side of the orifice and to transmit a detection signal to the controller.

### Advantageous Effect

The hydraulic system for a construction machine as configured above according to the aspect of the present invention has the following advantages.

When an overload occurs and the discharge pressure of the hydraulic pump exceeds a predetermined value of the relief valve, the loss of pressure in the relief valve can be reduced through reduction of the discharge flow rate of the hydraulic pump, and thus the fuel efficiency can be improved.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a hydraulic circuit diagram of a hydraulic system for a construction machine in the related art; and

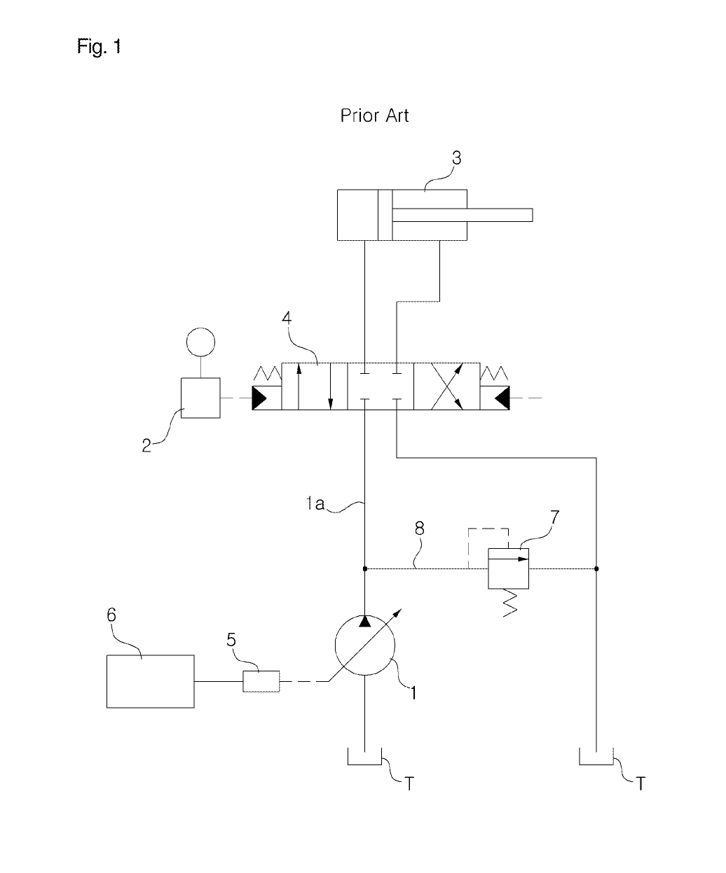

FIG. 2 is a hydraulic circuit diagram of a hydraulic system for a construction machine according to an embodiment of the present invention.

### DESCRIPTION OF REFERENCE NUMERALS IN THE DRAWING

11: variable displacement hydraulic pump
12: attachment operation device
13: attachment actuator
14: control valve
15: flow control valve of hydraulic pump
16: controller
17: relief valve
18: flow path
19: orifice
20: first pressure sensor
21: second pressure sensor

### BEST MODE

Hereinafter, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

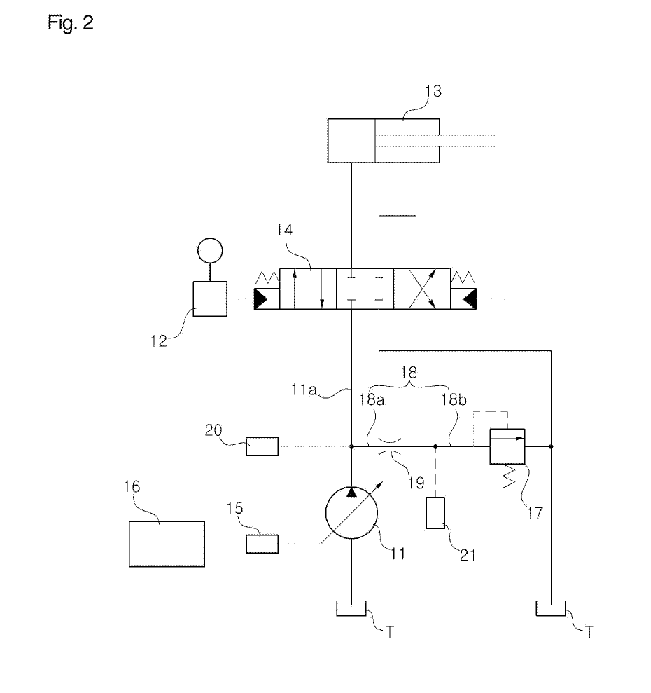

A hydraulic system for a construction machine according to an embodiment of the present invention, as illustrated in FIG. 2, includes a variable displacement hydraulic pump (hereinafter referred to as a “hydraulic pump”) 11 connected to an engine (not illustrated); an attachment operation device (e.g., joystick) 12 outputting an operation signal in proportion to an operation amount by an operator; an attachment actuator (e.g., boom cylinder) 13 connected to the hydraulic pump to be driven by an operation of the attachment operation device 12; a control valve 14 installed in a discharge flow path 11a between the hydraulic pump 11 and the attachment actuator 13 and shifted to control a start, a stop, and a direction change of the attachment actuator 13; an orifice 19 installed in a flow path 18 (18a and 18b) branched from the discharge flow path 11a of the hydraulic pump 11; a relief valve 17 installed on a downstream side (i.e., outlet side) of the orifice 19 in the flow path 18; and a controller 16 outputting a control signal to a flow control valve 14 of the hydraulic pump so as to reduce a discharge flow rate of the hydraulic pump 11 when a difference between pressures before and after the orifice 19 exceeds a predetermined value.

The hydraulic system for a construction machine according to an embodiment of the present invention further includes a first pressure sensor 20 installed in the discharge flow path 11a of the hydraulic pump 11 to detect in real time a discharge pressure of the hydraulic pump 11 and to transmit a detection signal to the controller 16; and a second pressure sensor 21 installed in a flow path 18b between the orifice 19 and the relief valve 17 to detect in real time a pressure on a downstream side of the orifice 19 and to transmit a detection signal to the controller 16.

Hereinafter, a use example of the hydraulic system for a construction machine according to an embodiment of the present invention will be described with reference to the accompanying drawing.

As shown in FIG. 2, if an operator operates the attachment operation device 12 so as to perform a boom-up drive, the control valve 14 is shifted in a rightward direction as shown in the drawing. In this case, hydraulic fluid that is discharged from the hydraulic pump 11 is supplied to a large chamber of the attachment actuator 13 through the discharge flow path 11a and a spool of the shifted control valve 14 in order. In this case, the hydraulic fluid that returns from a small chamber of the attachment actuator 13 that is driven to expand is drained to a hydraulic tank T through the shifted control valve 14.

In contrast, if the operator operates the attachment operation device 12 so as to perform a boom-down drive, the control valve 14 is shifted in a leftward direction as shown in the drawing. In this case, the hydraulic fluid that is discharged from the hydraulic pump 11 is supplied to the small chamber of the attachment actuator 13 through the discharge flow path 11a and the spool of the shifted control valve 14 in order. In this case, the hydraulic fluid that returns from the large chamber of the attachment actuator 13 that is driven to be compressed is drained to the hydraulic tank T through the spool of the shifted control valve 14.

As described above, according to the hydraulic system according to an embodiment of the present invention, the orifice 19 is installed in the flow path 18 that is branched from the discharge flow path 11a of the hydraulic pump 11, and pressure on an upstream side of the orifice 19 (i.e., discharge pressure of the hydraulic pump 11) and pressure on a downstream side of the orifice 19 (i.e., relief pressure) are measured in real time by the first and second pressure sensors 20 and 21. If a pressure ⁻difference between the measured pressures exceeds a predetermined value, the controller 16 determines that the present state is a relief state, and reduces the discharge flow rate of the hydraulic pump 11.

Specifically, the first pressure sensor 20 that is installed in the discharge flow path 11a detects in real time the discharge pressure of the hydraulic pump 11 and transmits a detection signal to the controller 16. At the same time, the second pressure sensor 21 that is installed in the flow path 18b detects in real time the pressure that passes through the orifice 19 and transmits a detection signal to the controller 16.

In this case, if the discharge pressure of the hydraulic pump 11 is lower than the relief pressure that moves toward the relief value 17, the relief value 17 is maintained in a closed state that is an initial state. Accordingly, the hydraulic fluid that is discharged from the hydraulic pump 11 does not move toward the relief value 17 through the orifice 19. That is, since the relief valve 17 is closed, a pressure difference before and after the orifice 19 does not occur (i.e., eh discharge pressure of the hydraulic pump 11 and the relief pressure of the flow path 18 become equal to each other).

In contrast, if the discharge pressure of the hydraulic pump 11 exceeds the predetermined pressure of the relief valve 17, the relief valve 17 is shifted to an open state. Through this, the hydraulic fluid which is discharged from the hydraulic pump 11 and moves along the discharge flow path 11a passes through the orifice 19 that is installed in the flow path 18. That is, the pressure difference between the discharge pressure of the hydraulic pump on the side of the discharge flow path 11a and the relief pressure on the side of the flow path 18 occurs (i.e., discharge pressure of the hydraulic pump on the side of the discharge flow path 11a>relief pressure on the side of the flow path 22).

As described above, if the pressure difference between the discharge pressure of the hydraulic pump 11 and the relief pressure that passes through the orifice exceeds the predetermined value, the inclination angle of a swash plate of the hydraulic pump 11 is controlled by a control signal (e.g., pilot signal pressure may be used) that is applied from the controller 16 to the flow control valve 15 of the hydraulic pump, and thus the discharge flow rate of the hydraulic pump 11 can be reduced. Through this, the consumed flow rate that is drained to the hydraulic tank t through the relief value 17 can be minimized.

On the other hand, even in the case where the discharge flow rate of the hydraulic pump 11 is reduced by the control signal that is applied from the controller 16 to the flow control valve 15 of the hydraulic pump, the discharge pressure of the hydraulic pump 11 becomes higher than the predetermined pressure of the relief valve 17, and thus the performance of the hydraulic system is maintained. Further, since energy that is consumed in the relief value 17 is reduced, the fuel efficiency can be improved.

### INDUSTRIAL APPLICABILITY

As apparent from the above description, according to the present invention having the above-described configuration, when an overload occurs and the discharge pressure of the hydraulic pump exceeds the predetermined value of the relief valve, the loss of pressure in the relief value can be reduced through reduction of the discharge flow rate of the hydraulic pump.

1. A hydraulic system for a construction machine, comprising:
a variable displacement hydraulic pump connected to an engine;
an attachment operation device outputting an operation signal in proportion to an operation amount by an operator;
an attachment actuator connected to the hydraulic pump to be driven by an operation of the attachment operation device;
a control valve installed in a flow path between the hydraulic pump and the attachment actuator and shifted to control a start, a stop, and a direction change of the attachment actuator;
an orifice installed in a flow path branched from a discharge flow path of the hydraulic pump;
a relief valve installed on a downstream side of the orifice in the flow path; and
a controller outputting a control signal to a flow control valve of the hydraulic pump so as to reduce a discharge flow rate of the hydraulic pump when a difference between pressures before and after the orifice exceeds a predetermined value.

2. The hydraulic system for a construction machine according to claim 1, further comprising:
a first pressure sensor installed in the discharge flow path of the hydraulic pump to detect in real time a discharge pressure of the hydraulic pump and to transmit a detection signal to the controller; and
a second pressure sensor installed in a flow path between the orifice and the relief valve to detect in real time a pressure on the downstream side of the orifice and to transmit a detection signal to the controller.
